(19) United States
(12) Patent Application Publication
(10) Pub. No.: US 2005/0188336 A1
(43) Pub. Date: Aug. 25, 2005

(54) System and method for waiving a verification check

(76) Inventors: Michael Peter Mortensen, Ft. Collins, CO (US); John Gilbert McBride, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/786,963

(22) Filed: Feb. 25, 2004

(51) Int. Cl. G06F 17/50

(52) U.S. Cl. 716/5; 716/4

(57) ABSTRACT

A system and method for waiving a verification check associated with a circuit design. In one embodiment, a first engine integrates waiver options associated with the circuit design's design objects into a hierarchical verification tree having the verification check. Responsive to a verification check violation, a second engine traverses a portion of the hierarchical verification tree to determine a list of applicable waivers. A third engine resolves the list of applicable waivers to determine the disposition of the verification check violation.

### BACKGROUND

As part of the design flow for a digital integrated circuit, it is essential to identify and quantify various requirements necessary to assure good performance over a wide range of events. Accordingly, both circuit simulation and physical design verification tools are utilized during design flow to ensure design quality. During verification, if a design quality rule (e.g., electrical rules, physical rules, and the like) is violated, there needs to be a disposition of that particular violation in an expeditious and efficient manner. By way of illustration, Electrical Rules Checking (ERC) is a process of checking a circuit to ensure that certain electrical rules are not violated. Examples of ERC checks include charge sharing from a latch node to an input node or a latch driver being too weak to set a latch. Typically, the checks are performed at the transistor level of a circuit, and when a check fails we say that we have an ERC violation.

In some cases, an electrical rule might serve as a general guideline that can (in carefully analyzed situations) be violated for some other reason, such as making a circuit smaller or faster. If a user is confident (based on analysis such as SPICE simulation or prior experience) that an ERC violation is not truly an error and can be ignored, the user can create a waiver (by editing a text file or through a graphical interface) that signals a specific ERC violation can be ignored and not reported as an error.

In one widely practiced methodology, waivers are effectuated by a text-based approach that matches the name of the rule violation with the name of the waiver with the aid of a Perl script or other interpreted scripting programming language. However, such resolution of waivers has proven difficult. In particular, in the analysis of any violation, every waiver must be considered.

### SUMMARY

A system and method are disclosed that provide for waiving a verification check associated with a circuit design. In one embodiment, a first engine integrates waiver options associated with the circuit design's design objects into a hierarchical verification tree having the verification check. Responsive to a verification check violation, a second engine traverses a portion of the hierarchical verification tree to determine a list of applicable waivers. A third engine resolves the list of applicable waivers to determine the disposition of the verification check violation.

### BRIEF DESCRIPTION OF THE DRAWINGS

FIG. 1 depicts a block diagram of one embodiment of a design flow scheme wherein a verification tool is operable to employ a system for waiving a verification check;

FIG. 2A depicts a block diagram of one embodiment of a system for integrating verification checks and waiver options;

FIG. 2B depicts a block diagram of one embodiment of the system for waiving verification checks;

FIG. 3 depicts a flow chart illustrating one embodiment of a method for waiving a verification check;

FIG. 4A depicts a circuit block example for illustrating an embodiment of the system for waiving verification checks; and

FIG. 4B depicts a portion of the circuit block of FIG. 4A in further detail.

### DETAILED DESCRIPTION OF THE DRAWINGS

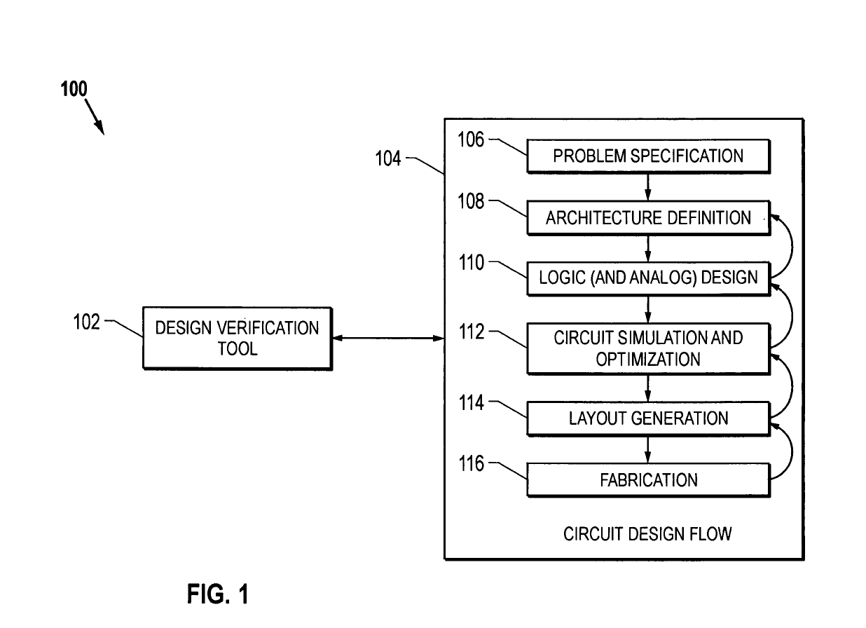

In the drawings, like or similar elements are designated with identical reference numerals throughout the several views thereof, and the various elements depicted are not necessarily drawn to scale. Referring now to FIG. 1, therein is depicted an embodiment of a design flow scheme 100 wherein a design verification tool 102 including a system for waiving a verification check may be employed. The design verification tool 102 may be utilized to verify the functionality and behavior of a circuit design at any point during circuit design flow 104, which in one embodiment includes the design phases of problem specification 106, architecture definition 108, logic and analog design 110, circuit simulation and optimization 112, layout generation 114, and fabrication 116. The problem specification phase 106 may include design review and incremental/iterative refinement of the problem until the level of detail allows for the gathering of the architectural requirements at which time the design process transitions to architectural definition phase 108 wherein high-level simulation and optimization may be performed. Successful high-level design operations lead to the logic and analog design phase 110 wherein gate and switch simulation and optimization are performed. If the logic design does not meet the required gate and switch specifications, however, the design flow may return to the architecture definition phase 108 as illustrated by the return flow arrow. Once the gate and switch simulation and optimization are complete, the design flow advances to the circuit simulation and optimization phase 112 wherein, for example, transistor design is tested. The next stage of the design flow 104 includes the layout generation phase 114 wherein circuit extraction including parasitics may occur. Upon satisfying the requirements of the layout generation phase 114, the circuit design proceeds to the fabrication phase 116.

The design verification tool 102 may comprise a circuit simulation tool including, e.g., an Electrical Rule Checker (ERC) and/or a physical verification tool including a Design Rule Checker (DRC), and may be employed at any phase of the circuit design flow 104. For instance, the verification tool 102 may operate at the architectural definition phase 108, logic and analog design phase 110, the circuit simulation and optimization phase 112, or layout generation phase 114. As will be explained in further detail hereinbelow, regardless of the type of verification being performed or the phase of the design flow, the system for waiving a verification check utilizes a hierarchical verification tree that includes the verification queries, i.e., electrical rule checks or design rule checks with respect to the circuit design, arranged in top-down fashion from the system to major subsystems to lower level design objects (i.e., cells and sub-cells, blocks and sub-blocks, nets and sub-nets, et cetera), including transistor-level objects (e.g., field-effect transistors or FETs). Waiver options, which may include instructions for waiving a violation, i.e., a waiver, or instructions for enabling a violation, i.e., an enabler, are integrated into the appropriate locations of the hierarchical verification tree. Upon generation of the results subsequent to executing the queries, the system traverses a portion of the hierarchical verification tree to determine a list of applicable waivers relative to each query check and associated design object. The system then resolves the list of applicable waivers to determine the disposition of the verification check results.

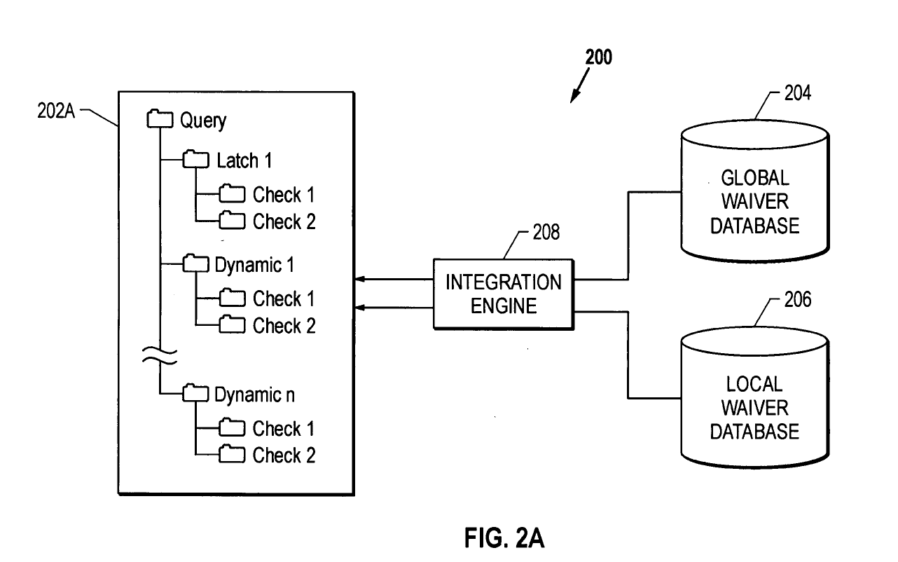

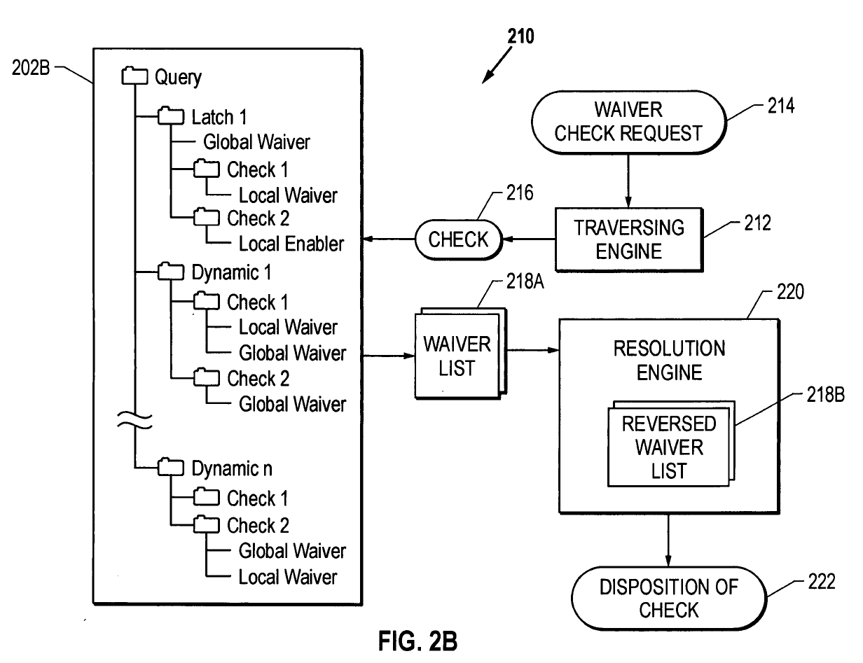

FIG. 2A depicts one embodiment of a system 200 for integrating one or more verification checks and waiver options relating thereto. A hierarchical verification tree 202A includes design objects relating to the verification queries that are arranged in a “tree” going from general to specific families of queries and ultimately to individual queries. The various queries associated with a circuit design (for example, a digital logic device such as a microprocessor) are accordingly categorized and grouped in nested branches of the hierarchical verification tree 202A based on the type and hierarchy of the design objects to which the queries pertain. At the highest level, a root node called Query includes all verification query checks that can possibly result in violations, arranged in branches and sub-branches of the tree. By way of illustration, a sample set of queries maybe organized into one or more latch-related queries, one or more dynamic logic-related queries, and the like. For example, the hierarchical verification tree 202A includes a first latch query category, i.e., Latch 1, and a plurality of dynamic logic instances, e.g., Dynamic 1 and Dynamic n. It should be appreciated that various other design objects such as an informational design object, for instance, may also be utilized. Latch 1 includes two individual design verification checks, Check 1 and Check 2. Similarly, Dynamic 1 and Dynamic n each include respectively two design verification checks. As previously alluded to, the hierarchical verification tree 202A may embody any design verification process. For example, the hierarchical verification tree 202A may embody the aforementioned ERC which is a process of checking a design circuit to ensure that certain electrical rules are not violated. In this embodiment, Check 1 and Check 2 of Latch 1 may be queries relative to charge sharing from a latch node to an input node or latch strength, i.e., determining if a latch driver is too weak to set a latch, for example. It should be appreciated that although each check may involve more than one design object, one design object is identified as the origin of the check. For example, consider the check LatchChargeSharingToInput. The latch design object is considered the originating design object even though other design objects or circuit elements such as an input may be involved.

The checks are performed on the circuit design to ensure that the circuit design is reliable and when a check fails, a violation is recorded. In some instances, however, a check in a design verification process, such as ERC, may serve as a general guideline that in particular situations may be violated for some reason, such as making a circuit smaller or faster. A design engineer may, for example, based on experience and/or circuit simulation determine that an ERC violation is not truly an error and the violation may be ignored. In order to ignore the violation, the design engineer creates a waiver option using a waiver syntax via a command line or graphical user interface to effectuate a violation being ignored and not reported as an error. By way of example, the waiver syntax may include the type of query check and the name of the design object to which the error refers. For example, to create a waiver for Check 1 on design object xyz, the design engineer may enter the statement Check 1:xyz in a (check):(design object) format. It should be appreciated that variations and modifications to this syntax are within the teachings disclosed herein. For example, to create a waiver for Check 1 on all design objects starting with xy, the wildcard character (*) may be employed and the statement Check 1:xy* may be entered by the design engineer.

The waivers that the design engineer creates are stored in a waiver database such as global waiver database 204 and/or local waiver database 206. In one embodiment, the global waiver database 204 may specify waivers created by the design team that apply to any block and the local waiver database 206 may specify waivers created by an individual design engineer for a block of particular interest to the design engineer. The design databases as well as the partitioning of the global and local waiver databases provide a measure of flexibility and configurability for the implementation of waivers. It should be appreciated that in addition to waivers, the global waiver database and local waiver database may include enabler statements that instruct the system not to waive a particular error for a design object. In other words, that particular violation is logged and reported, requiring a disposition thereof, either automatically or manually. An integration engine 208, i.e., a first engine, integrates the waiver options associated with the global waiver database 204 and the local waiver database 206 into the hierarchical verification tree 202A. For example, all checks relating to the first latch instance that are hierarchically organized under Latch 1 in the hierarchical verification tree 202A may be associated with one or more local and/or global waivers and/or related enablers.

FIG. 2B depicts one embodiment of the system 210 for waiving one or more verification checks wherein the hierarchical verification tree 202B includes the waiver options integrated from global waiver database 204 and local waiver database 206. In particular, under Latch 1, a global waiver from the global waiver database 204 is integrated. The global waiver applies to both Check 1 query and Check 2 query as signified by its position under Latch 1 at the same hierarchical level as Check 1 and Check 2. It should be appreciated that the term “global” in global waiver refers to the database from which the waiver option was integrated and not necessarily to the influence or applicability of the waiver option which is indicated by the waiver option's position within the hierarchical verification tree 202B. Continuing with the structure of the sub-hierarchical Latch 1 branch, a local waiver applies to Check 1 as is indicated by its association therewith. Similarly, a local enabler is associated with Check 2. As previously discussed, a local enabler may override a waiver regardless of its classification. For example, with respect to Check 2 of Latch 1, the local enabler associated therewith would override the global waiver applied to Latch 1. Continuing further with the illustrated example, a local waiver and a global waiver are associated with Check 1 of Dynamic 1. Similarly, a global waiver is associated with Check 2 of Dynamic 1 and both a global waiver and a local enabler are associated with Check 2 of Dynamic n. No waivers or other options are shown for Check 1 of Dynamic n.

In response to the execution of a design verification tool and the generation of a verification check violation, a traversing engine 212, i.e., a second engine, receives a waiver check request 214 and proceeds to traverse a portion of the hierarchical verification tree 202B to determine a list of applicable waivers relative to the particular check 216 which was violated. The traversing engine traverses from the leaf starting at the check that is violated up to the root. The traversing engine returns the applicable waivers in waiver list 218A. For example, if the waiver check request 214 and check 216 relate to Check 2 of Latch 1, then the traversing engine 212 starts the traversal at the leaf Check 2 under Latch 1 and returns the waiver list 218A which would include a global waiver and a local enabler.

A resolution engine 220, i.e., a third engine, receives the waiver list 218A and reverses the listing of the waiver options to create a reversed waiver list 218B, which is resolved by the resolution engine 220. In one embodiment, the reversal process is effectuated as follows. Starting at the leaf level and traversing up the tree, it should be recognized that at each level there can be both global waivers as well as local waivers. The waivers at each level are ordered, based on the order they were read in during the waiver integration process explained hereinabove. Since the global waivers are read in before the local waivers, the list at the each level (which may be referred to as a “sub-list”) is ordered with global waivers first (in the order shown in the waiver file) followed by local waivers (also ordered). As the verification tree is traversed upward, the sub-lists from each level are merged so that an ordered waiver list is obtained that first has the global waivers (if any) and then the local waivers (if any), wherein the waivers are all ordered by the order they occurred in the waiver files. Since it is desired that the local configuration waivers override global configuration waivers (i.e., an enabler in the local configuration/waiver file should undo or override a waiver in the global configuration/waiver file), and it is further desired that a configuration condition statement (i.e., a waiver or an enabler) that occurs later in a file take precedence over one from earlier in the same file, the ordered waiver list obtained upon completion of traversal is reversed so that the processing commences at the last and proceeds to the first configuration condition. As soon as a match (whether it is a waiver or an enabler) is found, the verification check is either waived or enabled and no further configuration statements need to be processed because the matching waiver or enabler was the one that would take precedence.

Accordingly, by reversing the list 218A to create reversed waiver list 218B, the waiver options with the greatest precedence may be considered first. A waiver option is considered to match the violated check if the design object, e.g., net (electrical node) or FET (transistor) matches the starting net or FET of the violated check. In one embodiment, as pointed out above, once a match is found, the reversed waiver list 218B is considered resolved. Additionally, if the waiver option specifies a second related waiver option, the violated check must also have the starting net or FET with respect to the second waiver option. The disposition of the verification check is then presented via interface 222 to the design engineer. It should be appreciated that the resolution engine 220 as well as the integration engine 208 and the traversing engine 212 may be effectuated by any computer implementation employing any combination of hardware, software, and firmware. Moreover, it should be apparent that the functionalities of the resolution engine 200, integration engine 208, and traversing engine 212 may be integrated into a design tool such as the previously described design verification tool 102 of FIG. 1.

Based on the foregoing, it should be appreciated that the computer-implemented scheme disclosed herein ensures rapid verification checks by employing the hierarchical verification tree such that a list of applicable waivers may be found orderly and efficiently. In particular, the present implementation does not require each waiver to be considered for each violation as required by the existing text-based methodologies. Additionally, the systems and methods disclosed herein minimize the misapplication of waivers. Specifically, the hierarchical verification tree implementation ensures that waivers with similar names, e.g., DynamicLatchDetected and DynamicFeedbackTooSmall, are not mistakenly misapplied.

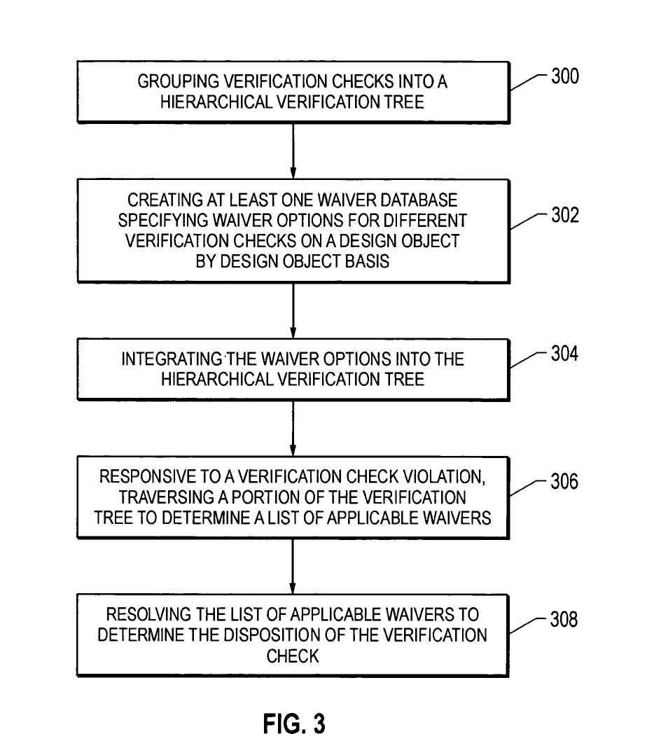

FIG. 3 depicts one embodiment of a method for waiving and resolving a verification check generated with respect to an IC design. At block 300, verification checks are grouped into a hierarchical verification tree depending upon the type of queries and the hierarchy of design objects they pertain to. At block 302, at least one waiver database is created to specify waiver options for different verification checks on a design object by design object basis. At block 304, the waiver options are integrated into the hierarchical verification tree. At block 306, responsive to a verification check violation, a portion of the verification tree is traversed to determine a list of applicable waivers. At block 308, the list of applicable waivers is resolved to determine the disposition of the verification check. In one embodiment, the resolution may include presenting the resolved list of applicable waivers to a design engineer via an interface such that the design engineer may decide whether or not to apply the waiver. Alternatively, the resolution may include determining the final disposition of the verification check, i.e., determining whether the violation of the verification check is waived, and presenting to the design engineer only the violations of the verification checks. In a further variation, a combination of automatic and manual resolution methodologies may be implemented.

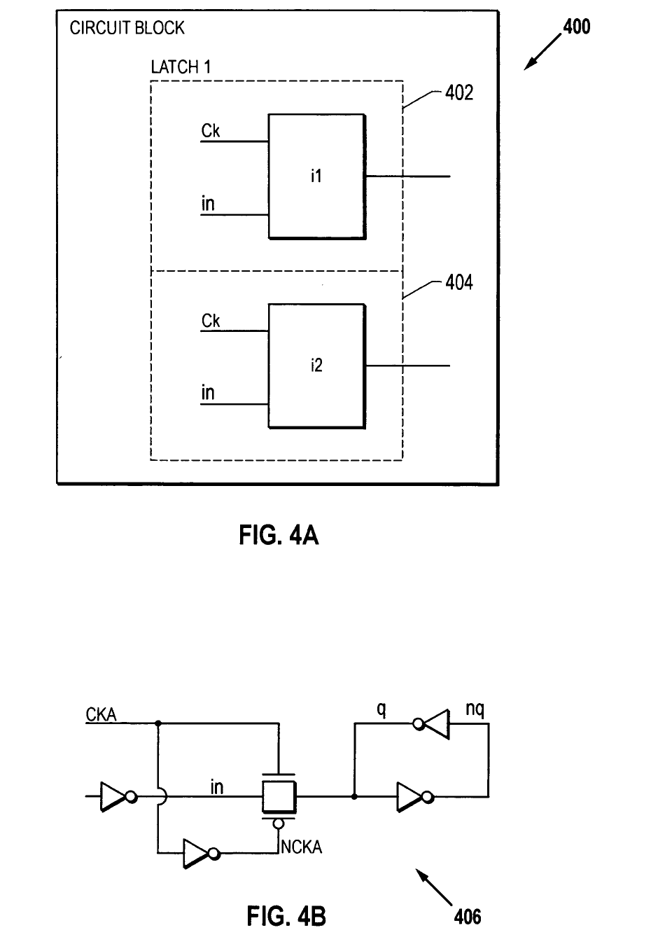

By way of example, FIG. 4A depicts a circuit block representation for illustrating an embodiment of the system for waiving verification checks. Circuit block 400 includes two instances of a latch, i.e., instance 1 (i1) 402 and instance 2 (i2) 404. FIG. 4B depicts a generic latch circuit 406 that is operable as either instance 1 402 or instance 2 404 of FIG. 4A. Each instance is provided with two internal nodes, in and q. Accordingly, as illustrated, the overall circuit block 400 includes design objects n1, n2, n3, i1/in, i1/q, i2/in, and i2/q, in conformity with the hierarchical nomenclature of the two instances. Those skilled in the art will recognize that these six design objects are illustrative nets of the circuit block 400 and there can be other design objects such as FETs that are not being considered in the present example. Further, suppose that design objects n1 and n2 are both dynamic nodes that violate a DynamicFeedbackTooSmall check. Similarly, design object n3 may be a latch node that violates the LatchSetting check and design objects i1-q and i2/q may be the nets that violate the LatchChSh2In check. The global waiver database associated with this example may include the following waiver options which are presented utilizing the {check}:{design object} syntax discussed hereinabove:
-subckt:LATCH1:LatchChSh2In:q
Dynamic:n*
The first statement relates to a sub-circuit-level waiver and the second statement waives all Dynamic queries on nodes that begin with the letter n. The local waiver database associated with this example may include the following waiver options:
DynamicFeedbackTooSmall:n*=y
LatchChSh2In:n3
LatchSetting:n3
The first of the three waiver options of the local waiver database allows DynamicFeedbackTooSmall to be reported, i.e., enabled or not to be waived, on any node starting with “n.” The second and third of the waiver options relate to design object n3 with respect to the two queries presented. Each of the five aforementioned errors are integrated into the hierarchical design tree.

In operation, the traversing engine traverses the hierarchical verification tree to find the applicable waivers relative to each query check and design object. Design objects n1 and n2 are both dynamic nodes that fail the DynamicFeedbackTooSmall check. Design object n3 is a latch node and fails the LatchSetting check. For design objects n1 and n2, which fail the DynamicFeedbackTooSmall check, the waiver list would include the following waivers:
Dynamic:n*
DynamicFeedbackTooSmall:n*=y
The initial ordering of the waivers reflects the order in which the waivers were read by the traversing engine. Upon receiving this list, the resolution engine reverses the list so that DynamicFeedbackTooSmall:n*=y waiver is considered first and the Dynamic:n* waiver is considered second. Since the start name for the waiver n* matches n1 and n2, both violations are allowed, i.e., enabled, and no further waivers are considered.

For the LatchSetting violation on n3, only the waiver LatchSetting:n3is extracted from the hierarchical verification tree. This check is waived by the resolution engine. For the second Latch error, i.e., i1/q fails the LatchChSh2In check, the traversing engine constructs the following list of waivers:
-subckt:LATCH1:LatchChSh2In:q
LatchChSh2In:n3
This list of waivers is forwarded to the resolution engine which reverses the list to read as follows:
LatchChSh2In: n3
-subckt:LATCH1:LatchChSh2In:q

The net i1/q fails the LatchChSh2In check, but does not match the first waiver resolved, i.e., the LatchChSh2In:n3 waiver. The net i1/q, however, matches the second waiver resolved, i.e., the -subckt:LATCH1:LatchChSh2In:q waiver, since the design object i1/q is the q design object inside an instance of cell LATCH1. Similarly, the net i2/q fails the LatchChSh2In query and is also waived by the -subckt:LATCH1:LatchChSh2In:q waiver. In one embodiment, the resolved verification checks are presented to the design engineer for consideration so that visibility into behavior of the circuit design may be obtained which is helpful in fine-tuning the circuit design flow.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

1. A system for waiving a verification check associated with a circuit design, comprising:
a first engine for integrating waiver options associated with said circuit design's design objects into a hierarchical verification tree having said verification check, said waiver options populating at least one waiver database;
responsive to a verification check violation, a second engine for traversing a portion of said hierarchical verification tree to determine a list of applicable waivers; and
a third engine for resolving said list of applicable waivers to determine the disposition of said verification check violation.

2. The system as recited in claim 1, wherein said at least one waiver database comprises a global waiver database that specifies waiver options applicable to at least a portion of said circuit design.

3. The system as recited in claim 1, wherein said at least one waiver database comprises a local waiver database that specifies waiver options applicable to at least a portion of said circuit design.

4. The system as recited in claim 1, wherein said waiver options include a waiver to waive said verification check violation.

5. The system as recited in claim 1, wherein said waiver options include an enabler to enable reporting of said verification check violation.

6. The system as recited in claim 1, wherein said design objects comprise an object selected from the group consisting of latch query design objects, dynamic logic query design objects, and informational query design objects.

7. The system as recited in claim 1, wherein said verification check violation relates to a verification query selected from the group consisting of Design Rules Checking (DRC) queries, Electrical Rules Checking (ERC) queries, functional verification queries, timing verification queries, and behavioral verification queries.

8. The system as recited in claim 1, wherein said third engine is operable to present said resolved list of applicable waivers to a design engineer via an interface.

9. A method for waiving a verification check associated with a circuit design, comprising:
grouping verification checks into a hierarchical verification tree;
creating at least one waiver database specifying waiver options for different verification checks on a design object by design object basis;
integrating said waiver options into said hierarchical verification tree;
responsive to a verification check violation, traversing a portion of said verification tree to determine a list of applicable waivers; and
resolving said list of applicable waivers to determine the disposition of said verification check violation.

10. The method as recited in claim 9, wherein the operation of creating at least one waiver database further comprises creating a global waiver database that specifies waiver options applicable to at least a portion of said circuit design.

11. The method as recited in claim 9, wherein the operation of creating at least one waiver database further comprises creating a local waiver database that specifies waiver options applicable to at least a portion of said circuit design.

12. The method as recited in claim 9, wherein the operation of resolving said list of applicable waivers further comprises waiving said verification check violation.

13. The method as recited in claim 9, wherein the operation of resolving said list of applicable waivers further comprises reporting said verification check violation.

14. The method as recited in claim 9, wherein the operation of grouping verification checks into a hierarchical verification tree is based on a query classification hierarchy.

15. The method as recited in claim 9, wherein said verification check violation relates to a verification query selected from the group consisting of Design Rules Checking (DRC) queries, Electrical Rules Checking (ERC) queries, functional verification queries, timing verification queries, and behavioral verification queries.

16. The method as recited in claim 9, further comprising presenting said resolved list of applicable waivers to a design engineer via an interface.

17. A computer-readable medium operable with a computer platform for supporting a hierarchical query verification tool associated with a circuit design, the medium having stored thereon:
instructions for grouping verification checks into a hierarchical verification tree;
instructions for creating at least one waiver database specifying waiver options for different verification checks on a design object by design object basis;
instructions for integrating said waiver options into said hierarchical verification tree;
instructions, responsive to a verification check violation, for traversing a portion of said verification tree to determine a list of applicable waivers; and
instructions for resolving said list of applicable waivers to determine the disposition of said verification check violation.

18. The computer-readable medium as recited in claim 17, wherein the instructions for creating at least one waiver database further comprise instructions for creating a global waiver database that specifies waiver options applicable to at least a portion of said circuit design.

19. The computer-readable medium as recited in claim 17, wherein the instructions for creating at least one waiver database further comprise instructions for creating a local waiver database that specifies waiver options applicable to at least a portion of said circuit design.

20. The computer-readable medium as recited in claim 17, wherein the instructions for resolving said list of applicable waivers further comprise instructions for waiving said verification check violation.

21. The computer-readable medium as recited in claim 17, wherein the instructions for resolving said list of applicable waivers further comprise instructions for enabling said verification check violation.

22. The computer-readable medium as recited in claim 17, wherein said hierarchical verification tree is based on a query classification hierarchy.

23. The computer-readable medium as recited in claim 17, wherein said verification check violation relates to a verification query selected from the group consisting of Design Rules Checking (DRC) queries, Electrical Rules Checking (ERC) queries, functional verification queries, timing verification queries, and behavioral verification queries.

24. The computer-readable medium as recited in claim 17, further comprising instructions for presenting said resolved list of applicable waivers to a design engineer via an interface.

25. A verification check waiver system, comprising:
means for grouping verification checks into a hierarchical verification tree;
means for creating at least one waiver database specifying waiver options for different verification checks on a design object by design object basis;
means for integrating said waiver options into said hierarchical verification tree;
means, responsive to a verification check violation, for traversing a portion of said verification tree to determine a list of applicable waivers; and
means for resolving said list of applicable waivers to determine the disposition of said verification check violation.

26. The verification check waiver system as recited in claim 25, wherein said means for creating at least one waiver database further comprises means for creating a global waiver database that specifies waiver options applicable to at least a portion of said circuit design.

27. The verification check waiver system as recited in claim 25, wherein said means for creating at least one waiver database further comprises means for creating a local waiver database that specifies waiver options applicable to at least a portion of said circuit design.

28. The verification check waiver system as recited in claim 25, wherein said means for resolving said list of applicable waivers further comprises means for waiving said verification check violation.

29. The verification check waiver system as recited in claim 25, wherein said means for resolving said list of applicable waivers further comprises means for enabling said verification check violation.

30. The verification check waiver system as recited in claim 25, wherein said hierarchical verification tree is based on a query classification hierarchy.

31. The verification check waiver system as recited in claim 25, wherein said verification check violation relates to a verification query selected from the group consisting of Design Rules Checking (DRC) queries, Electrical Rules Checking (ERC) queries, functional verification queries, timing verification queries, and behavioral verification queries.

32. The verification check waiver system as recited in claim 25, further comprising means for presenting said resolved list of applicable waivers to a design engineer via an interface.
